(19) United States
(12) Patent Application Publication
(10) Pub. No.: US 2016/0365948 A1
(43) Pub. Date: Dec. 15, 2016

(54) METHOD AND A SYSTEM FOR PACKET RECONSTRUCTION

(71) Applicant: Hitachi, Ltd., Tokyo (JP)

(72) Inventor: Ritesh Kumar KALLE, Bangalore (IN)

(73) Assignee: Hitachi, Ltd., Tokyo (JP)

(21) Appl. No.: 15/177,746

(22) Filed: Jun. 9, 2016

(30) Foreign Application Priority Data
Jun. 12, 2015 (IN) 2964/CHE/2015

(51) Int. Cl. H04L 1/00; G06F 11/10

(52) U.S. Cl. CPC H04L 1/0045; H04L 1/0083; G06F 11/1004; H04L 1/0061; H04L 69/324

(57) ABSTRACT

Embodiments of the present disclosure provide a system and a method for reconstruction of plurality of copies of data packets. The method comprising, receiving plurality of copies of data packets. The method further comprises generating a candidate packet from the plurality of copies of the data packets. Further, the method comprising, selecting at least two probable packets from the plurality of copies of data packets. For bye, the method comprises, receiving confidence factor of the at least two probable packets. Furthermore, the method comprising, determining the one or more common bits to be one of recovered bits and different bits, substituting each of the unrecovered bits of the candidate packet with one of the corresponding recovered bits and different bits of the probable packets. Lastly the method comprises, determining the unrecovered bits of the candidate packet using the packet Cyclic Redundancy Check (CRC) for reconstruction of the data packets.

### TECHNICAL FIELD

The present subject matter is related in general to the field of communication network, and more particularly to a method and a system to reconstruct data packets received by a networking protocol.

### BACKGROUND

As computers have grown into important tools that people use in all aspects of their business and personal lives, there has been an increased demand from computer users to have full use of computers regardless of location. To enable mobile computer use, computers frequently are equipped for wireless communications so that computer users can access information and services when away from their homes or offices. For these functions to be truly useful, it is desirable for wireless communication to be fast and reliable. To improve the speed and reliability of wireless communications, error control codes are implemented. Employing an error control code allows a receiving device to determine whether a packet of information has been received with an error. Errors occurs, for example, if noise in the communication channel causes the receiving device to incorrectly classify a received signal as representing a pattern of bits different than the pattern of bits that was sent by a transmitting device.

Depending on the characteristics of the error control code, the receiving device, in addition to simply detecting an error, may also be able to determine the nature of the error and correct it. Some error control codes can correct multiple errors, with the number of errors that can be corrected being dependent on characteristics of the code. Regardless of the characteristics of the error control code, there is a limit on the number of errors that can be corrected. Accordingly, communication protocols account for the possibility that a packet will be received with more errors than can be corrected or the packet will not be received at all.

Regardless of how the transmitting device determines that a packet was not received correctly, the transmitting device may respond to such a determination by retransmitting the packet until it receives an ACK or reaches a limit on the number of transmission attempts set by a protocol used by the transmitting device. The ability to detect and correct errors in received packets can improve the speed and reliability of communications because it avoids the need to retransmit a packet. A stronger code reduces the number of instances in which a packet has to be re-transmitted, this benefit is offset by the requirement for more bits per packet if a stronger code is used. A designer of a communication system may select strength of an error control code that balances both the positive and negative impacts on transmission speed to provide, on average, improved performance.

In some instances, a better balance can be achieved using nested error codes. Codes are nested by applying a first error control code to bits to be communicated in a packet. A second code may then be applied to the bits as modified using the first code. Further codes can be applied sequentially in this fashion to provide desired overall code strength. For example, it is known to first apply a Cyclic Redundancy Check (CRC), to bits to be transmitted. The CRC is a value selected so that when the CRC is combined in a mathematical operation with other bits in the packet, a known result occurs. If upon receipt, the known result does not occur when that mathematical operation is performed, it can be inferred that an error occurred such that the bits received do not match the bits transmitted. For example, the CRC may be a value that, when added with words formed by grouping the bits in the packet, produces a sum of zero. If, upon receipt, when the CRC is combined with other bits in the packet, the words do not sum to zero, it can be inferred that an error occurred. However, the conventional method performs CRC for each of the bits of the received data packet. This increases the number of computations, thereby increasing the time and memory consumed. Also, the use of CRC increases data overflow.

### SUMMARY

The one or more shortcomings of the prior art are overcome by a method and an evaluation system as claimed and additional advantages are provided through the provision of method and the evaluation system as claimed in the present disclosure.

Additional features and advantages are realized through the techniques of the present disclosure. Other embodiments and aspects of the disclosure are described in detail herein and are considered a part of the claimed disclosure.

In an aspect of the present disclosure, a method for reconstruction of data packets received by a networking protocol is provided. The method comprises, receiving plurality of copies of data packets by a packet processor of a transceiver system. The method further comprises, generating a candidate packet from the plurality of copies of the data packets using bitwise majority voting, wherein every bit of the candidate packet is categorized as one of recovered bit and unrecovered bit. Further, the method comprises, selecting at least two probable packets from the plurality of copies of data packets based on hamming distance and energy levels between the plurality of copies of data packets. For bye, the method comprises identifying status of one or more unrecovered bits of the at least two probable packets as one of common bits and different bits. Also, the method comprises, receiving confidence factor of the at least two probable packets, determining, by the packet processor the one or more common bits to be one of recovered bits and different bits, based on the confidence factor of the at least two probable packets, substituting each of the unrecovered bits of the candidate packet with one of the corresponding recovered bits and different bits of the probable packets. Lastly the method comprises determining the unrecovered bits of the candidate packet using the packet Cyclic Redundancy Check (CRC) for reconstruction of the data packets.

In one aspect, the present disclosure discloses a transceiver system for reconstructing data packets. The transceiver system comprises receiving plurality of copies of data packets transmitted from a transmitter system. The transceiver system comprises a packet processor configured to perform one of, generating a candidate packet using the plurality of copies of data packets based on bit wise majority voting, selecting at least two probable packets from the plurality copies of data packets based on hamming distance and received energy between the plurality copies of data packets, identifying status of each of the bits of the at least two probable packets based on one or more comparison parameters. Also, the packet processor evaluates every combination of the bits of the packet Cyclic Redundancy Check (CRC). Lastly, the packet processor substitutes the evaluated bits at the corresponding bit position in the generated candidate packet, thus reconstructing the transmitted plurality of copies of data packets.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates receiver architecture of a transceiver system in accordance with some embodiments of the present disclosure;

FIG. 2 shows an exemplary block diagram of a transceiver system in accordance with some embodiments of the present disclosure;

FIG. 3 shows an exemplary graph for decoding confidence of two most probable packets based on distance of received bit sequence in accordance with some embodiments of the present disclosure;

FIG. 4 shows a flowchart illustrating an exemplary method for reconstruction of data packets received by a networking protocol in accordance with some embodiments of the present disclosure;

FIG. 5 shows a flowchart illustrating exemplary method steps for bitwise majority voting to derive a candidate packet in accordance with some embodiments of the present disclosure;

FIG. 6 illustrates a flowchart illustrating a method to select two most probable packets from plurality of copies of data packets in accordance with some embodiments of the present disclosure;

FIG. 7 illustrates a flowchart illustrating a method to classify and isolate hidden errors among the most probable packets from the plurality of copies of data packets in accordance with some embodiments of the present disclosure;

FIG. 8 illustrates a flowchart illustrating an exemplary method for packet evaluation to compute candidate packet in accordance with some embodiments of the present disclosure; and

FIG. 9 is a block diagram of an exemplary computer system for implementing embodiments consistent with the present disclosure.

FIG. 10 is a diagram showing the selection of packet B and packet C as the most probable packets to determine the unrecovered bits of the candidate packet.

FIG. 11 is a diagram showing the identification of bits by the selection module.

FIG. 12 is a diagram showing the common bits among the packets B and C.

FIG. 13 is a diagram showing the assignment of a confidence factor to certain bit positions.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a method and a system to reconstruct plurality of copies of data packets received by a transceiver system.
In one embodiment, the present disclosure provides a transceiver system and a method to reconstruct data packets. The method comprises, receiving plurality of copies of data packets by a packet processor of a transceiver system. The method further comprises, generating a candidate packet from the plurality of copies of the data packets using bitwise majority voting, wherein every bit of the candidate packet is categorized as one of recovered bit and unrecovered bit. Further, the method comprises, selecting at least two probable packets from the plurality of copies of data packets based on hamming distance and energy levels between the plurality of copies of data packets. Forbye, the method comprises identifying status of one or more unrecovered bits of the at least two probable packets as one of common bits and different bits. Also, the method comprises, receiving confidence factor of the at least two probable packets, determining, by the packet processor the one or more common bits to be one of recovered bits and different bits, based on the confidence factor of the at least two probable packets, substituting each of the unrecovered bits of the candidate packet with one of the corresponding recovered bits and different bits of the probable packets. Lastly the method comprises determining the unrecovered bits of the candidate packet using the packet Cyclic Redundancy Check (CRC) for reconstruction of the data packets. In this way, the present disclosure provides a method and a system to achieve high reliable link layer packet reconstruction without explicit retransmission requests from the receiver of erroneous packets.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

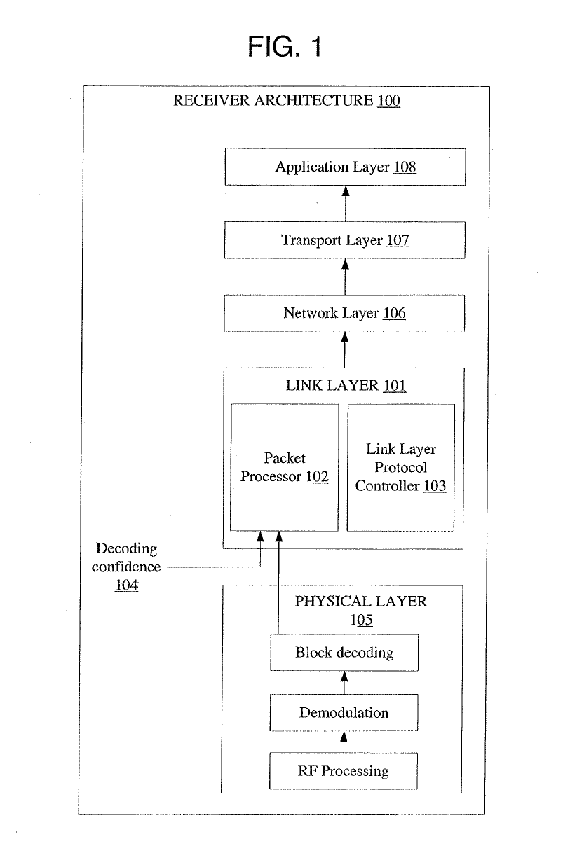

FIG. 1 illustrates receiver architecture 100 of a networking protocol in accordance with some other embodiments of the present disclosure. A packet processor 102 is configured in the link layer 101 of the networking protocol. In an embodiment, the packet processor 102 may be configured in a transceiver system. The link layer 101 of the networking protocol comprises a Link Layer Protocol controller 103. The link layer protocol controller 103 implements the control logic for state transitions, for e.g. transmission, reception, carrier sensing, acknowledgements etc. The plurality of copies of data packets is received by the packet processor 102 from a physical layer 105 of the networking protocol. Also, the packet processor 102 receives decoding confidence factor 104 of two most probable packets from physical layer 105 of the networking protocol. Plurality of copies of data packets are received by the link layer 101, which is passed to the higher layers of the network protocol error free, upon reconstruction of data packets.

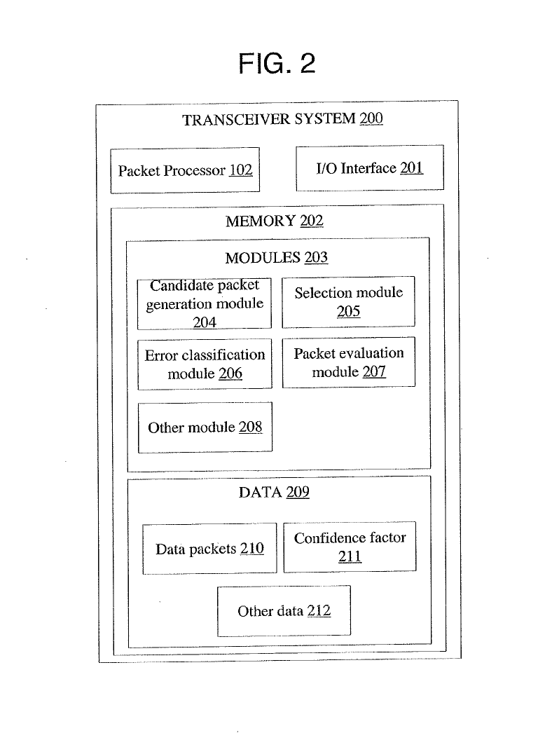

FIG. 2 illustrates an exemplary block diagram of a transceiver system 200 in accordance with some embodiments of the present disclosure. The transceiver system 200 may include at least one packet processor (“CPU” or “processor”) 102 and a memory 202 storing instructions executable by the at least one packet processor 102. The packet processor 102 may comprise at least one data processor for executing program components for executing user or system-generated requests. A user may include a person, a person using a device such as those included in this disclosure, or such a device itself. A memory 202 is communicatively coupled to the packet processor 102. In an embo+diment, the memory 202 stores one or more data 209. The transceiver system 200 further comprises an I/O interface 201. The I/O interface 201 is coupled with the packet processor 102 through which an input signal or/and an output signal is communicated.

In one embodiment, one or more data 209 may be stored within the memory 202. The one or more data 209 may be plurality of copies of data packets 210 received from a transceiver system or a transmitter system. Further, the one or more data 209 may be confidence factor 211 received from physical layer 105 of the transceiver system 200. Also, the one or more data 209 may comprise other data 212. The other data 212 may be used to store data, including temporary data and temporary files, generated by modules 203 for performing the various functions of transceiver system 200.

In an embodiment, the one or more data 209 in the memory 202 is processed by modules 203 of the transceiver system 200. The modules 203 may be stored within the memory 202. In an example, the one or more modules 203, communicatively coupled with the packet processor 102, may also be present outside the memory 202. As used herein, the term module refers to an application specific integrated circuit (ASIC), an electronic circuit, a processor (shared, dedicated, or group) and memory 202 that execute one or more software or firmware programs, a combinational logic circuit, and/or other suitable components that provide the described functionality.

In one implementation, the modules may include, for example, a candidate packet generation module 204, a selection module 205, an error classification module 206, a packet evaluation module 207 and other modules 208. It will be appreciated that such aforementioned modules may be represented as a single module or a combination of different modules.

In an embodiment, the candidate packet generation module 204 generates a candidate packet, from the received plurality of copies of data packets 210. The candidate packet is derived using bit wise majority voting. The candidate packet is stored in the memory 202, which is further utilized by the packet evaluation module 207 of the packet processor 102. The candidate packet holds an estimate of final packet derived using bit wise majority voting.

In an embodiment, the method of bit wise majority voting computes the subset of the candidate packet. In an embodiment, the bit wise majority voting is performed on odd number of copies of data packets 210. This is because in even number of copies, a decision cannot be determined due to equal number of zeroes and ones at particular bit positions in the plurality of copies of data packets. Further, the conclusive bits are marked as “recovered bits” and the inconclusive bits are marked as “unrecovered bits”.

In an example embodiment, consider a transmitted data packet having bit sequence: T=11000101. Let A, B, C and D be the received plurality of copies of data packets with bit streams:

A=11001010;

B=10010101;

C=10001101; and

D=11000010;

In an embodiment, a candidate packet is derived from the received plurality of copies of the data packets. The candidate packet generation module 204 generates a candidate packet for the received packets A, B, C and D. For the received packets, the candidate packet may have the bit sequence:

Candidate Packet=1X00XXXX;

where, 1, 0 represent the conclusive/recovered bits; and

X represents inconclusive/unrecovered bits.

From the above candidate packet, only three bit positions are determined. The determined bit positions are marked as “recovered bits”. The undetermined bits are marked as “unrecovered bits”.

In an embodiment, the selection module 205 selects two most probable packets from the plurality of copies of data packets 210. The selection is based on hamming distance and energy levels between the plurality of copies of data packets 210. Further, the selection module 205 identifies the unrecovered bit positions of the two most probable packets as one of “common bits” and “different bits”.

In the example embodiment, the selection module 205 selects two most probable packets from the received data packets A, B, C and D. As an example implementation, consider the data packets 210 with predefined hamming distance and Energy Level function/Received Signal Strength Indication function (RSSI function). Table 1 below shows the hamming distance and energy level function (RSSI function) for the received data packets A, B, C and D:

TABLE 1

| Probable Packet Pairs | Hamming Distance | RSSI Function |
|---|---|---|
| h_{AB} | 6 | 4 |
| h_{AC} | 4 | 6 |
| h_{AD} | 1 | 5 |
| h_{BC} | 2 | 12 |
| h_{BD} | 5 | 8 |
| h_{CD} | 5 | 6 |

The selection module 205 selects the two most probable packets such that, the ratio of the energy function and the corresponding hamming distance is maximum among probable packet pairs. From Table 1, the maximum ratio is 6 (12/2). The corresponding packet pair is considered as the most probable packets. Hence packet B and packet C are determined as most probable packets to determine the unrecovered bits of the candidate packet.

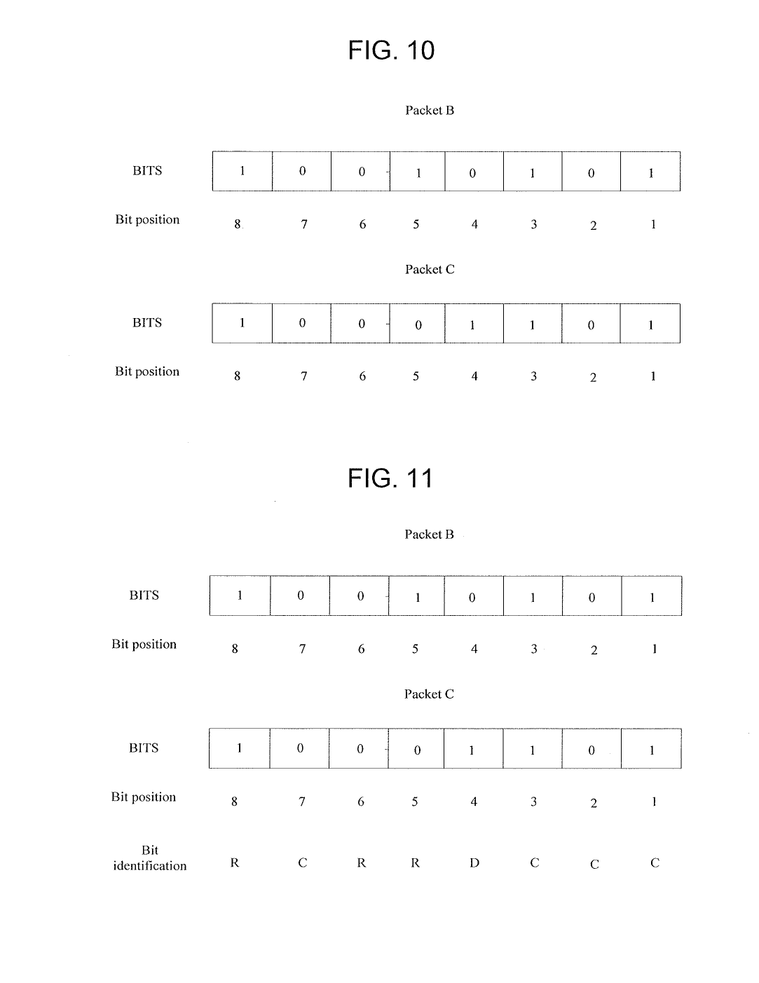

In an embodiment, the selection module 205 identifies the unrecovered bit positions of the two most probable packets as one of “common bits” and “different bits”. From the above example embodiment, the identification of each of the bits of the most probable packets is illustrated in FIG. 10.

In FIG. 10, the selection module 205 categorizes each of the unrecovered bits into one of, common bits and different bits. The similar bits at a predefined bit position in each of the probable packets are identified as common bits. The dissimilar bits at a predefined bit position in each of the probable packets are identified as different bits. From the candidate packet, the unrecovered bit positions are 1, 2, 3, 4 and 7. Hence, these bit positions are considered for identification by the selection module 205.

At bit position 1, 2, 3 and 7, each of the packets B and C have similar bit value. Hence, these bit position is identified as common bit. At bit position 4, the bit values of each of the packets B and C are dissimilar. Hence, this bit position is identified as different bit. FIG. 11 represents the identification of bits by the selection module 205.

In one embodiment, the error classification module 206 receives the two most probable packets from the selection module and the corresponding confidence factor 211 of the packet from the physical layer 105 of the transceiver system 200. The error classification module 206 categorizes the common bits of the two most probable packets as one of, recovered bits and different bits, based on the confidence factor 211 of the at least two probable packets. Further, the error classification module 206, substitutes each of the unrecovered bits of the candidate packet with one of the corresponding recovered bits and different bits of the two most probable packets.

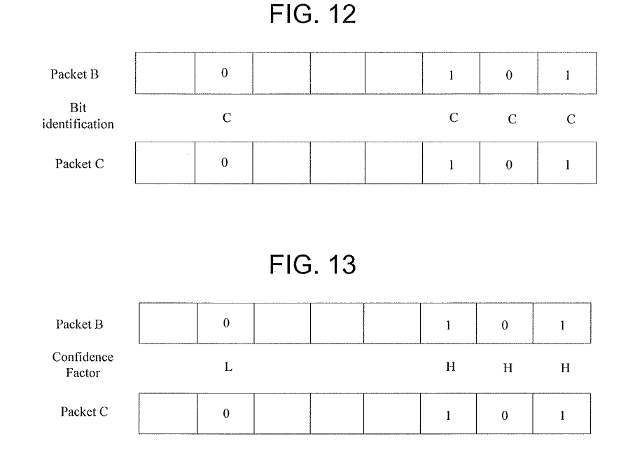

In the example embodiment, the error classification module 206 receives the two most probable packets B and C to determine the common bits of the candidate packet. The common bits among the packets B and C are at bit positions 1, 2, 3 and 7 as shown in FIG. 12.

Also, the error classification module 206 receives the corresponding confidence factor 211. Let the confidence factor for the bit positions 1, 2, 3 and 7 of the packets B and C be, High, High, High and Low respectively as shown in FIG. 13.

The common bits at these bit positions are marked one of, recovered bits and different bits. The bit positions having a High confidence in each of the most probable packets are categorized as recovered bits. The bit positions having one of, Low confidence and dissimilar logic states in each of the most probable packets are categorized as different bits. In packets B and C, the bit positions 1, 2, and 3 have a logic High confidence. Thus, these bit positions are marked as recovered bits. The bit position 7 of the packets B and C is marked logic Low. Hence, this bit position is marked as different bit. Further, the error classification module 206 substitutes the recovered bits and the different bits in the candidate packet at the corresponding bit positions. The candidate packet after the substitution may be:

Candidate packet=1D00D101

The bit positions of the each of the packets in this disclosure are named in the increasing order from the right most bit of the packet. All the references of bit positions made in this disclosure follow similar conventions.

In one embodiment, the packet evaluation module 207 determines the unrecovered bits of the candidate packet using the packet Cyclic Redundancy Check (CRC) for reconstruction of the data packets. The CRC takes place for every combination for each of the unrecovered bits in the candidate packet until the CRC is satisfied.

In the example embodiment, the packet evaluation module 207 determines each of the unrecovered bits in the candidate packet using the packet CRC. Let the confidence of the bit position 4 be logic High. The packet CRC is performed on each of the different bits by successively inverting the bit positions marked Low in increasing order of hamming distance from the candidate packet. Further, the packet CRC is performed on each of the different bits successively inverting the bit positions marked High in increasing order of hamming distance from the candidate packet. The packet CRC on the data packets may be:

Trial 1=10000101

Trial 2=11000101

The error classification module 207 terminates the packet CRC once the energy level of the candidate packet matches the energy level of the transmitted packet. Thus, in the above example, the CRC is terminated after computing the trail 2 packet. Hence, the trial 2 packet resembles the transmitted packet, thus resulting in successful reconstruction of data packets.

In one embodiment, the packet processor 102 of the transceiver system 200 may transmit an acknowledgement message to one or more networking layers to prevent retransmission of the plurality of copies of data packets 210.

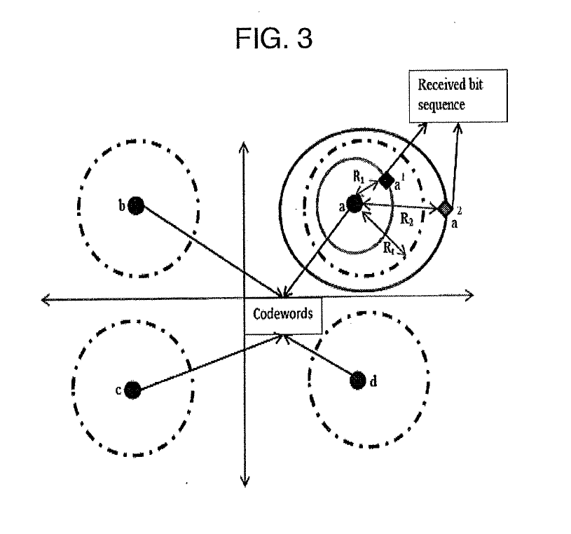

FIG. 3 of the present disclosure shows a graph for decoding confidence factor 211 of the two most probable packets based on distance of received bit sequence, in accordance with other embodiments of the present disclosure. The decoding confidence is a metric indicating the closeness of the received bit sequence to the transmitted bit sequence. The graph shows each of the bits of the corresponding plurality of copies of data 210 mapped across bit sequence of transmitted data packet. The received plurality of copies of data packets 210 may not be the same as the bit sequence of the transmitted data packets due to at least one of, noise, interference, etc. Hence, decoding confidence of the two most probable packets 111 is carried out using maximum likelihood approach method. The method comprises mapping the received bits of the plurality of copies of data packets 210 to the nearest bit sequence of the transmitted data packet.

In an example embodiment, the maximum likelihood approach may consider distance between the received bit sequence of the plurality of copies of data packets 210 and the bit sequence of the transmitted data packets. The distance between the received bit sequence and transmitted bit sequence may be one of, Hamming distance, Euclidean distance, Energy vector, etc. A threshold distance is predefined such that, if the distance between the received bit sequence and the transmitted bit sequence is less than the threshold distance, that bit is marked with a predefined logic level. If the distance between the received bit sequence and the transmitted bit sequence is greater than the threshold distance, that bit is marked with a predefined logic level. For e.g. the below implementation represents confidence of two bit sequence based on the distance:

Confidence=1, Rᵢ<Rₜ

Confidence=0, Rᵢ>Rₜ

where, Rᵢ is the distance between a received bit sequence and the transmitted bit sequence and Rₜ is the predefined threshold distance.

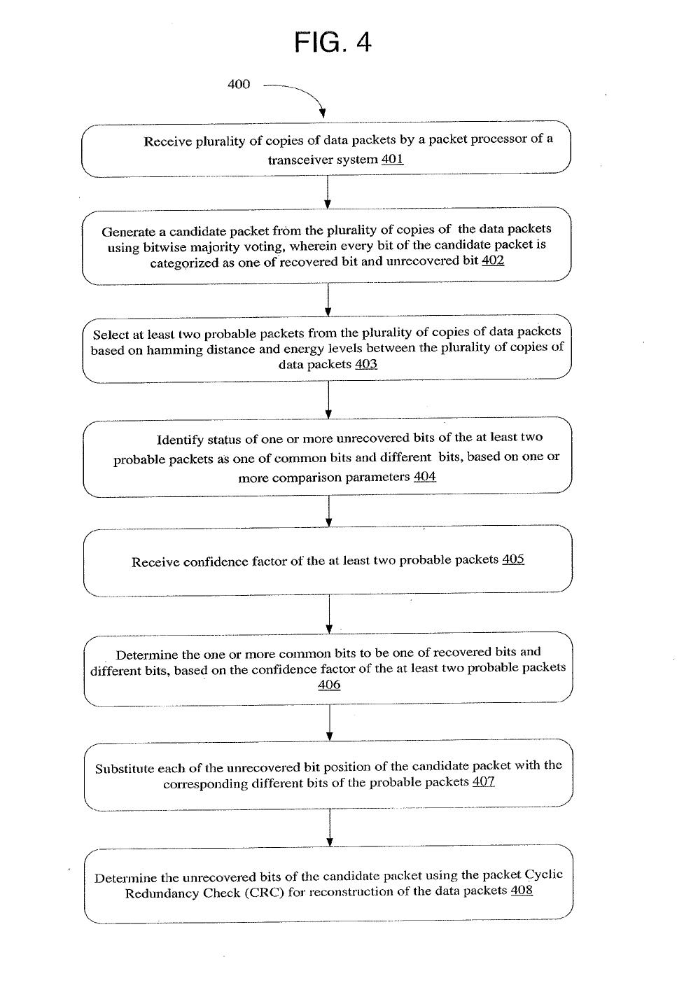

FIG. 4 shows an exemplary flowchart illustrating a method for reconstruction of data packets received by a networking protocol, in accordance with some other embodiments of the present disclosure.

As illustrated in FIG. 4, the method 400 comprises one or more blocks for reconstructing plurality of copies of data packets 400 received by a networking protocol. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 401, receive plurality of copies of data packets 210 by a packet processor 102 of a transceiver system 200. The transceiver system 200 receives plurality of copies of data packets 210 from a transmitter system or a transceiver system, from one or more communication channels. Further, the packet processor 102 of the transceiver system 200 receives plurality of copies of data packets 210 from the physical layer 204 of the transceiver system 200. The received plurality of copies of data packets 210 may be subjected to signal processing techniques. Based on wireless channel characteristics, error bits of the received plurality of copies of data packets 210 may be non-uniformly distributed across the multiple copies.

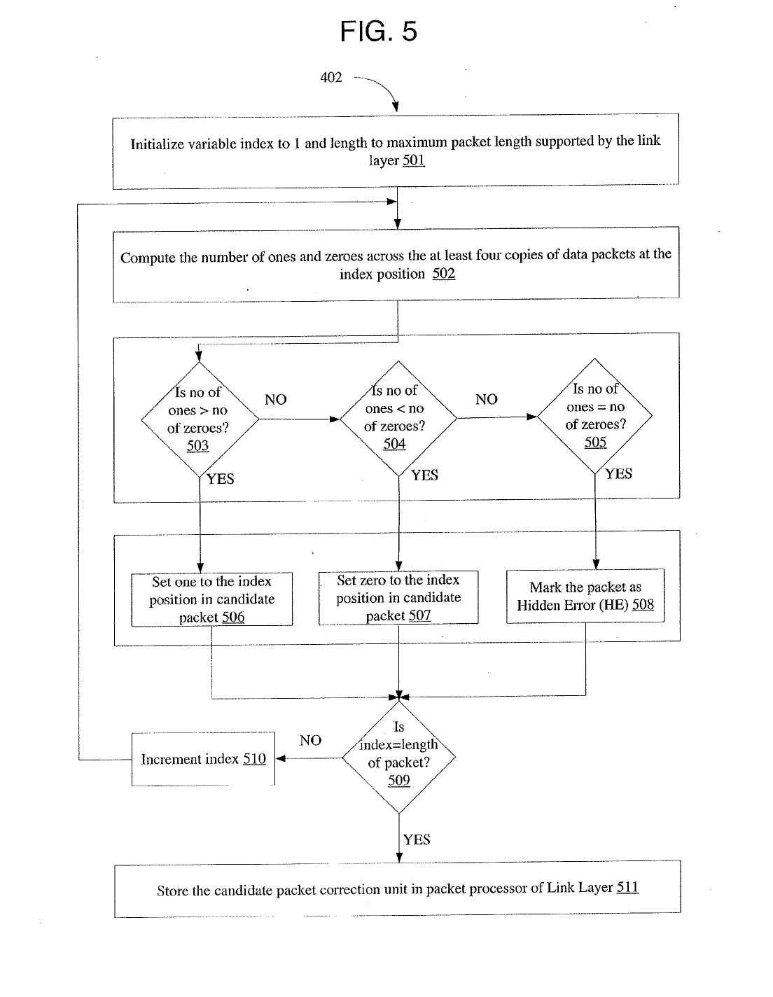

At step 402, generate a candidate packet from the plurality of copies of data packets 210 using bit wise majority voting. The candidate packet is stored in the memory 202, which is further utilized by the packet evaluation module 207 of the packet processor 102. The candidate packet holds an estimate of final packet derived using bit wise majority voting. The method further comprises, categorizing every bit of the candidate packet as one of, recovered bits and unrecovered bits. The method of generating the candidate packet is illustrated in FIG. 5 of the present disclosure.

In an embodiment, FIG. 5 shows an exemplary flowchart for bitwise majority voting to derive a candidate packet, with other embodiments of the present disclosure.

At step 501, initialize variable index to a predefined value and length to maximum packet length supported by the link layer. The candidate packet generation module 204 initializes the variable index to a predefined value and the packet length to maximum length of plurality of copies of data packets 210.

At step 502, compute the number of ones and zeroes across the plurality of copies of data packets 210, at the index position. The method comprises computing the number of predefined binary values of the plurality of copies of data packets 210, for e.g. ones and zeroes, at a predefined bit position.

At step 503, compare the number of ones and zeroes of the plurality of copies of data packets 210 at the predefined bit position. If the number of ones is greater than the number of zeroes, the method proceeds to step 506 via YES.

At step 506, assign logic bit one to the index position of the candidate packet. The method proceeds to step 509.

In the alternative, if the number of ones is not greater than the number of zeroes, the method proceeds to step 504 via NO. At step 504, if the number of ones is lesser than the number of zeroes, the method proceeds to step 507 via YES.

At step 507, assign logic bit zero to the index position of the candidate packet. The method proceeds to step 509.

In the alternative, if the number of ones is neither greater nor less than number of zeroes, the method proceeds to step 505 via NO. At step 505, if the number of ones is equal to number of zeroes, the method proceeds to step 508 via YES.

At step 508, mark the index position of the candidate packet as unrecovered bit, since the bit comprises hidden error. The method proceeds to step 509.

At step 509, compare the index with the length of the packet. If the index value does not match the length value, the method proceeds to step 510 via NO.

At step 510, the value of index is incremented. Then, the method comprises traversing the steps from 502, until the value of index matches the value of length.

In the alternative, if the index value matches the length value of the packet, the method proceeds to step 508 via YES. At step 511, the candidate packet is stored in the memory 202. The candidate packet comprises recovered bits and unrecovered bits. The candidate packet is stored in the memory 202 and is utilized further to recover the unrecovered bits.

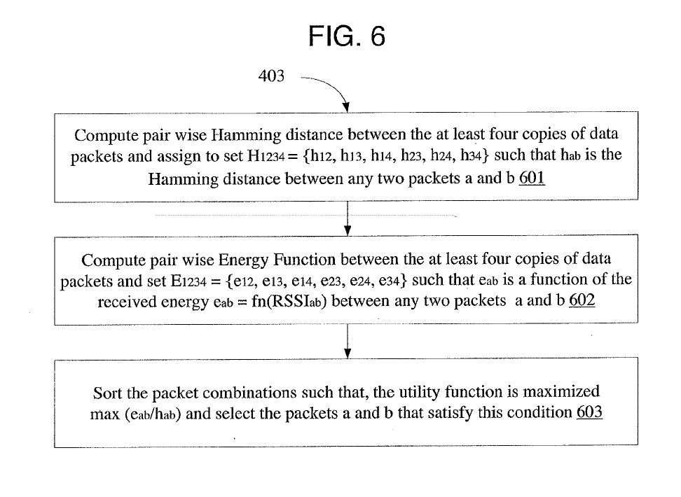

Referring back to FIG. 4, at step 403, select, by the selection module 205 of the packet processor 102, at least two probable packets from the plurality of copies of data packets based on hamming distance and energy levels between the plurality of copies of data packets. The two probable packets are selected to recover the one or more unrecovered bits of the candidate packet. The method for selecting two most probable packets from the received data packets 210 is illustrated in FIG. 6 of the present disclosure.

In an embodiment, FIG. 6 illustrates a method to select two most probable packets from plurality of copies of data packets, in accordance with other embodiments of the present disclosure.

At step 601, compute Hamming distance between the plurality of copies of data packets 210, by the selection module 205. The method comprises computing hamming distance between received bit sequence and transmitted bit sequence. Each bit sequence is assigned a predefined value based on the closeness of the received bit sequence with the transmitted bit sequence.

At step 602, compute pair wise Energy function between the plurality of copies of data packets 210, by the selection module 205. The method comprises, comparing energy levels of each of the received plurality of copies of data packets 210 with transmitted data packet.

At step 603, sort the packet combination among the plurality of copies of data packets 210 by the selection module 205. The method comprises computing for every combination, the ratio of, energy level between two data packets among the plurality of copies of data packets 210 to the hamming distance between the two data packets. Further, the method comprises sorting the packet combination with the maximum ratio as the two most probable packets.

Referring back to FIG. 4, at step 404, identify, by the selection module 205 of the packet processor 102, status of one or more unrecovered bits of the at least two probable packets as one of common bits and different bits. The method comprises, comparing bits of the two most probable packets, for a given bit position. The bits are marked common bits if the compared bits are equal and the bits are marked different bits if the compared bits are unequal.

At step 405, receive confidence factor 211 of the two most probable packets by the error classification module 206 of the packet processor 102. The confidence factor 211 is received by the packet processor 102 from the physical layer 204 of the transceiver system 200. The confidence factor 211 is derived based on the hamming distance of the received bit sequence and the transmitted bit sequence.

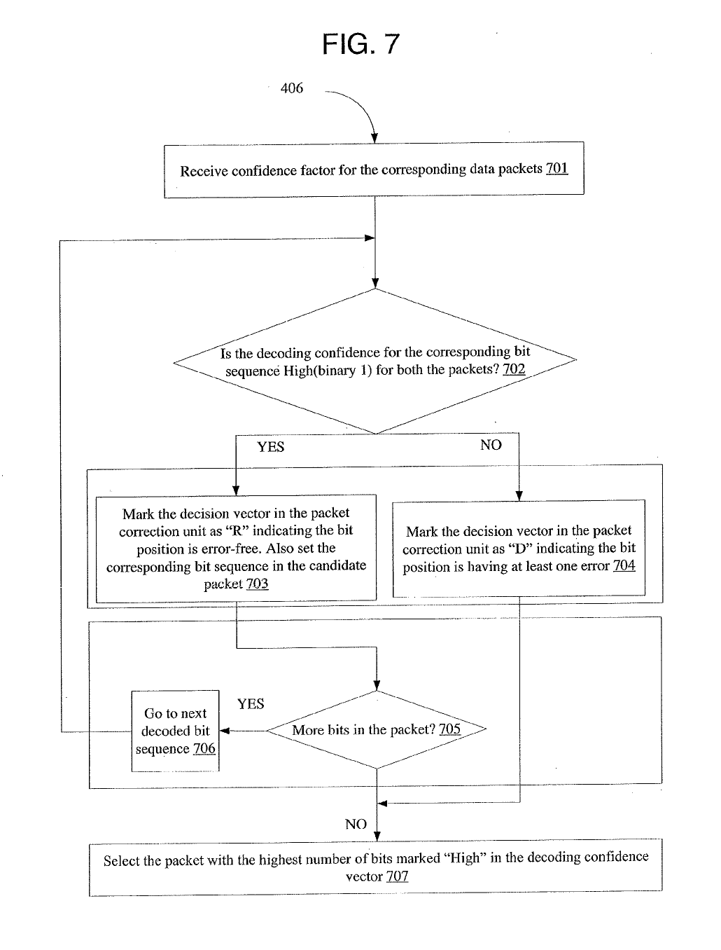

At step 406, determine, by the error classification module 206 of the packet processor 102, the one or more common bits to be one of, recovered bits and different bits. The determination of the common bits is based in the confidence factor 211 of the two most probable packets. The method comprises classifying the common bits as recovered bits, if the confidence factor 211 for a given bit position in each of the most probable packets is at predefined logic levels. Also, the method comprises classifying the common bits as different bits, if the confidence factor 211 for a given bit position in each of the most probable packets is at different predefined logic levels. The method for determining the common bits in the most probable packets is illustrated in FIG. 7 of the present disclosure.

In an embodiment of the present disclosure, FIG. 7 illustrates a method to classify and isolate common bits in the most probable packets, in accordance with other embodiments of the present disclosure.

At step 701, receive, by the error classification module 206, the corresponding confidence factor 211 from the physical layer 204 of the transceiver system 200. The confidence factor 211 is a metric indicating the closeness of the received bit sequence to the transmitted bit sequence. The confidence factor 211 is determined for each of the bits of the two most probable packets.

At step 702 examine, by the error classification module 206, the confidence factor for each of the common bits of the two most probable packets. The method comprises verifying whether the confidence factor of each of the bit of the most probable packets, for a predefined bit position, is logic high. If both the bits of the probable packets at a given bit position is logic high, the method proceeds to step 703 via YES.

At step 703, assign a decision vector having the common bits as recovered bits indicating the bit is error free. Further, the method proceeds to step 705.

In an alternative, if both the bits of the probable packets at a given bit position is not logic high, the method proceeds to step 704 via NO. At step 704, the common bits are marked different bits indicating the bit position is having at least one error. Further, the method proceeds to step 707.

At step 705, the error classification module 206 checks for more bits in the decision vector. If there are more bits in the packet, the method proceeds to step 706 via YES.

At step 706, the bit position is incremented and steps 702 to 705 are performed for every bit position of the decision vector.

In an alternative, if there are no more bits on the packet, the method proceeds to step 707 via NO. At step 707, the error classification module 206 selects the packet with highest number bits marked logic high in the confidence factor 211.

Referring back to FIG. 4, at step 407, substitute each of the unrecovered bit position of the candidate packet with the corresponding different bits of the most probable packets by the error classification module 206 of the packet processor 102.

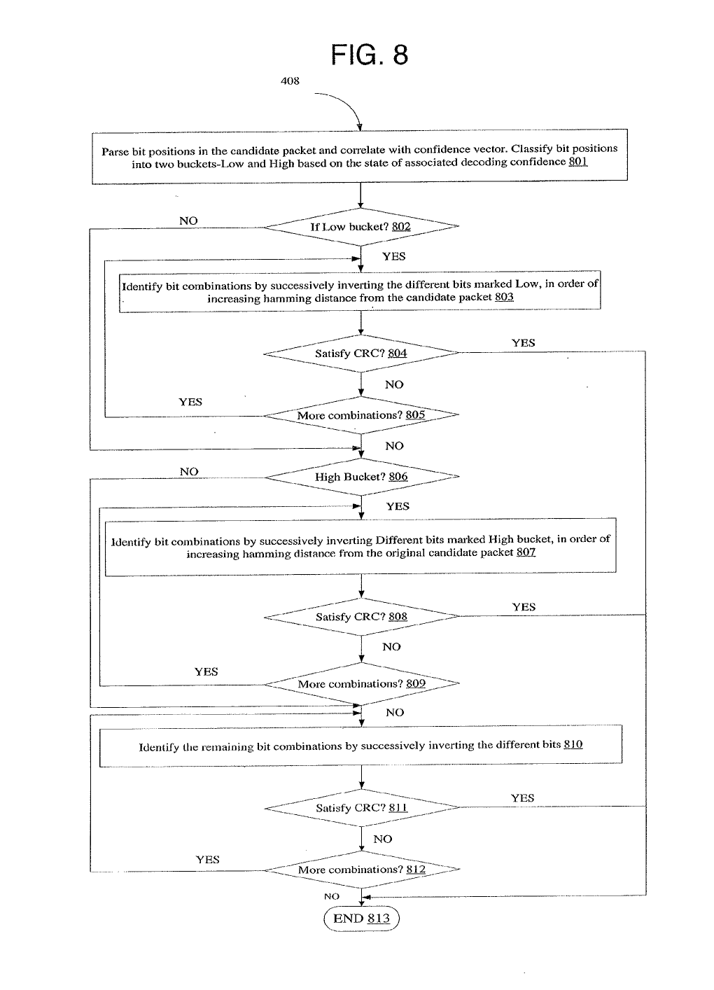

At step 408, determine the unrecovered bits of the candidate packet using packet Cyclic Redundancy Check (CRC) for reconstruction of the data packets 210. The method comprises performing CRC for every combination for each of the unrecovered bits in the candidate packet until the CRC is satisfied. The data packet 210 is recovered once the candidate packet satisfies the CRC. The method for performing CRC on the candidate packet is illustrated in FIG. 8 of the present disclosure.

In an embodiment, FIG. 8 illustrates an exemplary method for packet evaluation to compute candidate packet, in accordance with other embodiments of the present disclosure.

At step 801, the packet evaluation module 207 receives the candidate packet to be evaluated. The candidate packet comprises at least one of, recovered bits and different bits. The method further comprises, correlating the each of the bits of the candidate packet with the confidence factor 211 for the corresponding bits. Furthermore the method comprises classifying bit positions of the candidate packet into one of, low bucket and high bucket based on the state of the associated decoding confidence factor 211 for the corresponding bits.

At step 802, the packet evaluation module identifies the bit positions of the candidate packet. If the bit position is marked low bucket, the method proceeds to step 803.

At step 803, the packet evaluation module identifies the bit combinations by successively inverting the different bits marked low bucket in order of increasing hamming distance from the candidate packet. Further, the method proceeds to step 804.

Referring back to step 802, if the bit position is marked high bucket, the method proceeds to step 806.

At step 804, the method comprises verifying the candidate packet to be the transmitted data packet. If the verification is satisfied, the method proceeds to step 813.

In an alternative, if the verification is not satisfied, the method proceeds to step 805. At step 805, the method checks for more bit combinations. If there are more bit combinations marked low bucket, the method steps back to 803. In an alternative, if there are no more bits a combination, the method proceeds to step 806.

At step 806, the packet evaluation module identifies the bit positions marked high bucket. If the bit position is marked high bucket, the method proceeds to step 807.

As an alternative, if there are no bits combination marked high bucket, the method jumps to step 810.

At step 807, the packet evaluation module identifies the bit combinations by successively inverting the different bits marked high bucket in order of increasing hamming distance from the candidate packet. Further, the method proceeds to step to 808.

At step 808, the method comprises verifying the candidate packet to be the transmitted data packet. If the verification is satisfied, the method proceeds to step 813.

In an alternative, if the verification is not satisfied at step 808, the method proceeds to step 809. At step 809, the method checks for more bit combinations. If there are more bit combinations marked high bucket, the method steps back to 807. In an alternative, if there are no more bits a combination, the method proceeds to step 810.

At step 810, identify the remaining bits combinations by successively inverting the different bits. Further, the method proceeds to step to 811.

At step 811, the method comprises verifying the candidate packet to be the transmitted data packet. If the verification is satisfied, the method proceeds to step 813.

In an alternative, if the verification is not satisfied at step 811, the method proceeds to step 812. At step 812, the method checks for more bit combinations. If there are more bit combinations marked high bucket, the method steps back to 810. In an alternative, if there are no more bits a combination, the method proceeds to step 813.

At step 809, the plurality of copies of data packets are recovered. Hence, the received data packets are error free.

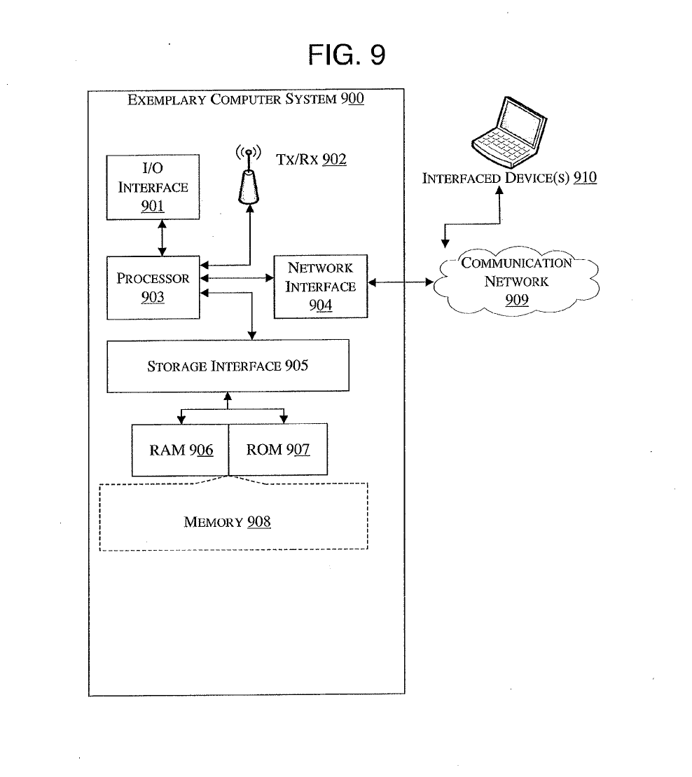

FIG. 9 of the present disclosure illustrates an exemplary block diagram of a computer system 900 for implementing embodiments consistent with the present disclosure.

The computer system 900 comprises an I/O interface 901, a transceiver system 902, a processor 903, a network interface 904, communication network 909, a storage interface 905, a RAM 906, a ROM 907 and a memory 908.

Variations of computer system 900 may be used for implementing all the computing systems that may be utilized to implement the features of the present disclosure. Computer system 900 may comprise a central processing unit (“CPU” or “processor”) 102. Processor 903 may be at least one packet processor for executing program components for executing user- or system-generated requests. The processor 903 may include specialized processing units such as integrated system (bus) controllers, memory management control units, floating point units, graphics processing units, digital signal processing units, etc. The processor 903 may include a microprocessor, such as AMD Athlon, Duron or Opteron, ARM's application, embedded or secure processors, IBM PowerPC, Intel's Core, Itanium, Xeon, Celeron or other line of processors, etc. The processor 903 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 903 may be disposed in communication with one or more input/output (I/O) devices via I/O interface 901. The I/O interface 901 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

In some embodiments, the processor 903 may be disposed in communication with a communication network 909 via a network interface 904. The network interface 902 may communicate with the communication network 909. The network interface 904 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 909 may include, without limitation, a direct interconnection, local area network (LAN), wide area network (WAN), wireless network (e.g., using Wireless Application Protocol), the Internet, etc. Using the network interface 904 and the communication network 909, the computer system 900 may communicate with devices 910. These devices 910 may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 901 may itself embody one or more of these devices.

In some embodiments, the processor 903 may be disposed in communication with one or more memory devices (e.g., RAM 905, ROM 906, etc.) via a storage interface 905. The storage interface 905 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Advantages of the embodiments of the present disclosure are illustrated herein.

In an embodiment, the present disclosure illustrates a method and a transceiver system for reconstructing plurality of copies of data packets by a networking protocol.

In an embodiment, the present disclosure provides a method and a system to achieve high reliable link layer packet reconstruction without explicit retransmission requests from the receiver of erroneous packets.

In an embodiment, the present disclosure provides a method to distinguish erroneous and correct packets in case of hidden errors.

In an embodiment, the present disclosure provides a method that can operate without support of any explicit Automatic Repeat Request (ARQ) and forward error correction code (FEC) applied to the communication system.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4, FIG. 5, FIG. 6, FIG. 7 and FIG. 8 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for reconstruction of data packets received by a networking protocol, the method comprising:
receiving, by a packet processor of a transceiver system, plurality of copies of data packets;
generating, by the packet processor, a candidate packet from the plurality of copies of the data packets using bitwise majority voting, wherein every bit of the candidate packet is categorized as one of recovered bit and unrecovered bit;
selecting, by the packet processor, at least two probable packets from the plurality of copies of data packets based on hamming distance and energy levels between the plurality of copies of data packets;
identifying, by the packet processor, status of one or more unrecovered bits of the at least two probable packets as one of common bits and different bits;
receiving, by the packet processor, confidence factor of the at least two probable packets;
determining, by the packet processor, the one or more common bits to be one of recovered bits and different bits, based on the confidence factor of the at least two probable packets;
substituting, by the packet processor, each of the unrecovered bits of the candidate packet with one of the corresponding recovered bits and different bits of the probable packets; and
determining, by the packet processor, the unrecovered bits of the candidate packet using the packet Cyclic Redundancy Check (CRC) for reconstruction of the data packets.

2. The method as claimed in claim 1, wherein the bit wise majority voting comprises estimating number of zeros and ones across each of the plurality of copies of data packets.

3. The method as claimed in claim 1, wherein decoding confidence comprises binary values for every bit of the plurality of copies of data packets based on the Hamming distance.

4. A packet processor of a transceiver system for reconstruction of data packets received by a networking protocol, the packet processor is configured to:
receive plurality of copies of data packets;
generate a candidate packet from the plurality of copies of the data packets using bitwise majority voting, wherein every bit of the candidate packet is categorized as one of recovered bit and unrecovered bit;
select at least two probable packets from the plurality of copies of data packets based on hamming distance and energy levels between the plurality of copies of data packets;
identify status of one or more unrecovered bits of the at least two probable packets as one of common bits and different bits;
receive confidence factor of the at least two probable packets;
determine the one or more common bits to be one of recovered bits and different bits, based on the confidence factor of the at least two probable packets;
substitute each of the unrecovered bits of the candidate packet with one of the corresponding recovered bits and different bits of the probable packets; and
determine the unrecovered bits of the candidate packet using the packet Cyclic Redundancy Check (CRC) for reconstruction of the data packets.

5. The packet processor as claimed in claim 5, wherein the packet processor is configured in the link layer of the transceiver system.

6. The packet processor as claimed in claim 5, wherein bit wise majority voting performed by the packet processor comprises, estimating number of zeros and ones across each of the at least four copies of data packets.

7. The packet processor as claimed in claim 5, wherein the packet processor receives the confidence factor comprising binary values for every bit of the plurality of copies of data packets based on at least one of, bit energy level of the plurality of copies data packets, distance between reference energy level of the plurality of copies of data packets and received energy level between plurality of copies of data packets.
